(19) United States
(12) Patent Application Publication
(10) Pub. No.: US 2025/0272927 A1
(43) Pub. Date: Aug. 28, 2025

(54) METHOD FOR ACHIEVING VIRTUAL TOUCH CONTROL WITH VIRTUAL THREE-DIMENSIONAL CURSOR, A STORAGE MEDIUM AND A CHIP IMPLEMENTING SAID METHOD

(71) Applicant: JONG-GUANG PAN, Liaoning Province (CN)

(72) Inventor: JONG-GUANG PAN, Liaoning Province (CN)

(21) Appl. No.: 18/918,124

(22) Filed: Oct. 17, 2024

(30) Foreign Application Priority Data
Feb. 28, 2024 (CN) 202410218070.8

(51) Int. Cl. G06T 19/00; G02B 27/01; G06F 3/01

(52) U.S. Cl. CPC G06T 19/006; G02B 27/0172; G06F 3/014; G02B 2027/0178

(57) ABSTRACT

A method for achieving virtual touch control, a storage medium, and a chip; applicable to systems using XR wearable devices or headsets, where in a virtual space, a weighted mean position of a joint or fingertip or a plurality of joints of a human hand which a light ray projected from a preset light source passes through before projecting further to a distant position is a control aiming point; the light ray projected from the preset light source towards the distant position is an interactive control line, and the three-dimensional cursor or a pen tip is displayed at a distal end of the interactive control line. A fast spatial position calculation method and a fast touch determination method are used for the interactive control line with definite or indefinite length formed through a bare hand to achieve virtual touch control, writing or drawing in a 3D virtual space.

### TECHNICAL FIELD

The present invention relates to the field of virtual touch control technology, and particularly relates to a method for achieving virtual touch control with a virtual three-dimensional cursor, a storage medium and a chip implementing said method. The present invention is applicable to an extended reality (XR) wearable device, or more particularly to an extended reality headset.

### BACKGROUND OF THE INVENTION

Extended reality (XR) refers to an environment of combined reality and virtuality allowing human-machine interaction realized by computer technologies and human wearable devices, and it is a general term encapsulating augmented reality (AR), virtual reality (VR), and mixed reality (MR). With the popularization and development of XR in various industries, various XR glasses have emerged, which achieve interaction between a user and a system by inputs through a virtual keyboard and touch control.

When using an XR glasses intelligent terminal, the user sees the world in two screens with two eyes, and the world seen is different from two-dimensional images seen from a mobile phone, a tablet, and a conventional display screen. The world seen through the binocular display screens of an XR glasses is three-dimensional. User may move and click a simple cursor on a conventional two-dimensional screen based on (X, Y) coordinates. However, in a three-dimensional space, user cannot move and click a conventional cursor in a three-dimensional (X, Y, Z) space particularly with the depth dimension. Generally, an XR glasses intelligent terminal uses a remote controller, a gamepad, a mobile phone, or other similar sensors to express a “straight line” like that of a laser projected by a laser pen or a “curve” like that of a launched fishing rod to control a position of the cursor in a three-dimensional space. A more proximal virtual object can be virtually touched or operated with a finger or a gesture. At present, none of the disclosed patents or non-patent literatures in which a bare hand can be used to direct a cursor to a distant position discloses a method for calculating a three-dimensional position of the cursor based on visual images.

### BRIEF SUMMARY OF THE INVENTION

It is an object of the present invention to provide a method for achieving virtual touch control with a three-dimensional cursor, and a storage medium and a chip implementing said method. The present invention achieves touch control operations, writing, or drawing in a three-dimensional virtual space by forming an interactive control line with a definite or indefinite length through a bare hand.

A method for achieving virtual touch control with a three-dimensional cursor, applicable to a system using an extended reality wearable device or an extended reality headset; wherein in a virtual space, a weighted mean position of a certain joint or fingertip or a plurality of joints of a human hand which a light ray projected from a preset light source passes through before projecting further to a distant position is defined as a control aiming point; the light ray projected from the preset light source, passing through the control aiming point, and being projected onto the distant position is defined as an interactive control line, and the three-dimensional cursor is displayed at a distal end of the interactive control line; the method comprises the following steps:

Step 1: assigning a trigger region for the control aiming point, and assigning at least one switch finger for activating projection of the three-dimensional cursor and at least one click finger for touching the trigger region;

Step 2: when any one of said at least one switch finger touches the trigger region, spatial positions of the control aiming point and the preset light source are acquired, and then the light ray projected from the preset light source, passing through the control aiming point, and being projected onto the distant position forms said interactive control line; before said at least one click finger has ever clicked the trigger region, the interactive control line disappears once said at least one switch finger leaves and does not touch the trigger region; when there is the interactive control line, changing a direction which the control aiming point points is capable of guiding the interactive control line to move; when the interactive control line and a virtual object or a virtual model of a real object in a virtual space intersect, the three-dimensional cursor is displayed at that intersecting point, and if at this moment, the click finger also touches the trigger region, virtual touch control is performed on the virtual object or the virtual model touched by the three-dimensional cursor.

Specific calculation for acquiring the spatial positions of the control aiming point and the preset light source comprises the following steps:

If the preset light source is positioned within a visible range of a pair of XR intelligent glasses, and is also a certain preset joint, yet not being said control aiming point, on any one of two hands, then the spatial positions of the control aiming point and the preset light source are acquired by using a same calculation method as follows: treating a connecting line passing through central points L/R of both left and right cameras of the XR intelligent glasses as an X-axis, and in a field of vision of the left camera, an included angle defined as TΘL is formed between the X-axis and a connecting line connecting the central point L of the left camera and a targeted joint point whose spatial position is yet to be calculated; similarly, in a field of vision of the right camera, an included angle defined as TΘR is formed between the X-axis and a connecting line connecting the central point R of the right camera and a targeted joint point T whose spatial position is yet to be calculated; a parallax distance between the two central points L and R of the left and right cameras is set as d, and a position (X, Z) of the targeted joint point is calculated as follows:
if the targeted joint point T is located between the two central points L and R of the left and right cameras:

$$Z = d / [ TAN ( T θ L ) - TAN ( T θ R - π / 2 ) ] , X = Z * TAN ( T θ L ) ; \qquad ( 1 )$$

if the targeted joint point T is located on a left side of the central point L of the left camera:

$$Z = d / [ TAN ( T θ R - π / 2 ) - TAN ( T θ L - π / 2 ) ] , X = - Z * TAN ( T θ L ) ; \qquad ( 2 )$$

if the targeted joint point T is located on a right side of the central point R of the right camera:

$$Z = d / [ COT ( T θ L ) - COT ( T θ R ) ] , X = Z / Tan ( T θ L ) ; \qquad ( 3 )$$

a reference point for determination of a Y-axis value is any point on a lowest side of video images perceived from the left and right cameras; a Y pixel value of the targeted joint point T counted upwards from the reference point is the Y-axis value of a spatial position (X, Y, Z) of the targeted joint point T;

If the preset light source is not positioned within the visible range of the XR intelligent glasses, the spatial position of the preset light source is calculated by a method different from that of the method for calculating the spatial position of the control aiming point as described above; the spatial position of the preset light source is calculated as follows: a relative position relative to a central point (X_{center}, Y_{center}) of the XR intelligent glasses between the left and right cameras is used as the preset light source; if a joint or a fingertip of a thumb of a right hand is used as the control aiming point, a position of the preset light source (X_{light source}, Y_{light source}) being the relative position relative to the central point of the XR intelligent glasses is defined as X_{light source}=X_{center}+βx, and Y_{light source}=Y_{center}−βy; if the a joint or a fingertip of a thumb of a left hand is used as the control aiming point, a position of the light source (X_{light source}, Y_{light source}) being the relative position relative to the central point of the XR intelligent glasses is defined as X_{light source}=X_{center}−βx, and Y_{light source}=Y_{center}−βy, wherein βx and βy are offset values.

Steps for determining whether a trigger finger P being said at least one switch finger or said at least one click finger touches the trigger region:
the trigger region assigned to the control aiming point is set with a width W; a left trigger determination point WL and a right trigger determination point WR are set at positions W/2 to the left and W/2 to the right of a central point of the trigger region respectively along a direction parallel to an X-axis, in other words, the left trigger determination point WL and the right trigger determination point WR are points corresponding to left and right boundaries of the trigger region respectively; the system acquires N number of video streams with parallax from at least two cameras of the XR intelligent glasses, wherein N is an integer, and N≥2, track and determine whether the trigger fingertip P is located between the left trigger determination point WL and the right trigger determination point WR corresponding to the trigger region in all corresponding N number of images bearing a same time from said N number of video streams respectively, and if yes, calculate positional information of three target points which are the left trigger determination point WL, the trigger fingertip P, and the right trigger determination point WR for each of said N number of images bearing the same time; then in each of said N number of images bearing the same time, X-axis values (WRX, PX, and WLX) of the positional information of the three target points in that image are used to calculate a ratio (PX−WRX):(WLX−PX) which is a difference in value between PX and WRX to a difference in value between WLX and PX; only when all ratios calculated in all of said N number of images bearing the same time are the same, the trigger fingertip P is determined to have touched the trigger region.

The virtual touch control refers to that the fingertip of a thumb is set as the control aiming point; one of remaining four fingers is selected as the click finger; and at least one of yet remaining three fingers is set as the switch finger for activating projection of the three-dimensional cursor; if a plurality of switch fingers are set, the plurality of switch fingers are defined to activate different functions.

The virtual touch control refers to that the fingertip of a thumb is set as the control aiming point; one of remaining four fingers is selected as the switch finger for activating projection of the three-dimensional cursor; and two of yet remaining three fingers are respectively defined as a right mouse button click finger and a left mouse button click finger.

The interactive control line is a projected light ray of an indefinite length, which is a straight light ray or a parabolic light ray.

The interactive control line is a virtual paintbrush with a preset length; while displaying the virtual paintbrush, by touching the trigger region with the click finger, a pen tip of the virtual paintbrush draws points or strokes in the virtual space, thereby achieving a function of drawing or writing.

A head-mounted display device, at least comprising two cameras configured to take videos and/or images of a targeted region; the head-mounted display device comprises a memory and a processor; wherein the memory is configured to store a computer program; the processor is configured to execute the computer program to perform any one of the methods for achieving virtual touch control with the three-dimensional cursor according to the present application.

A computer readable storage medium, in which a computer program is stored, wherein the computer program, when executed by the processor, performs any one of the methods for achieving virtual touch control with the three-dimensional cursor according to the present application.

A chip for executing commands, wherein the chip comprises an integrated circuit substrate encapsulated inside, and the integrated circuit substrate is configured to perform any one of the methods for achieving virtual touch control with the three-dimensional cursor according to the present application.

According to the present invention, a weighted mean position of a certain joint/fingertip or a plurality of joints which a light ray projected from a preset light source passes through before projecting further to a distant position is defined as a control aiming point of the three dimensional cursor; a position of the preset light source is preset on a hand joint or any body part whose position is calculated relative to a center point of the XR intelligent glasses; the light ray of definite or indefinite length is projected from the preset light source, passing through the control aiming point, and eventually being projected onto the distant position, such that a remote three dimensional cursor or a virtual paintbrush controllable by a bare hand can be formed, thereby achieving virtual touch control or writing or drawing in a three dimensional virtual space. The present invention has the following technical effects:

1. The XR intelligent glasses of the present invention calculate three dimensional positional information (X, Y, Z) of a finger joint based on images from a plurality of cameras and a parallax or a physical distance between the cameras, thereby quickly obtaining the three dimensional positional information of a control aiming point and a preset light source, thus enabling an interactive control line to be projected from the preset light source passing through the control aiming point.

2. A trigger region is assigned to the control aiming point, and at least one switch finger for activating projection of the three dimensional cursor as well as at least one click finger for touching the trigger region is also assigned. When the switch finger touches the trigger region, the spatial positions of the control aiming point and the preset light source are acquired, and then a light ray projected from the preset light source passing through the control aiming point forms the interactive control line; before the click finger has ever clicked the trigger region, the interactive control line will disappear once the switch finger leaves and does not touch the trigger region. When there is the interactive control line, changing a direction which the control aiming point points to can guide the interactive control line to move; when the interactive control line and a virtual object or a virtual model of a real object in a virtual space intersect, a three-dimensional cursor is displayed at that intersecting point, and if at this moment, the click finger also touches the trigger region, virtual touch control is performed on the virtual object or the virtual model touched by the three-dimensional cursor. According to the above technical solutions, the present invention achieves touch control operations, writing, or drawing in a three-dimensional virtual space by forming an interactive control line with a definite or indefinite length through a bare hand.

### BRIEF DESCRIPTION OF THE DRAWINGS

FIG. 1 shows 21 recognizable joint points on a human hand and names thereof given on the Mediapipe official website;

FIG. 2 is a schematic diagram of calculating spatial positions of targeted joint points through a left camera of a pair of XR intelligent glasses according to the present invention;

FIG. 3 is a schematic diagram of calculating spatial positions of targeted joint points through a right camera of a pair of XR intelligent glasses according to the present invention;

FIG. 4 is a schematic diagram of complete three-dimensional information of two joint points of a single finger through the use of corresponding Y-axis values according to the present invention;

FIG. 5 is a schematic diagram of two alternative interactive control lines formed by projection of light rays from preset light sources whose relative position are calculated relative to a center point of the XR intelligent glasses and where the light rays project to distant positions by passing through fingertips of two thumbs respectively on their way according to the present invention;

FIG. 6 is a schematic diagram of a ring finger as a switch finger when implementing left and right mouse button control according to the present invention;

FIG. 7 is a schematic diagram of an index finger as a right button click finger when implementing left and right mouse button control according to the present invention;

FIG. 8 is a schematic diagram of a middle finger as a left button click finger when implementing left and right mouse button control according to the present invention;

FIG. 9 is a schematic diagram of a relative positioning of the trigger fingertip and two trigger determination points in combined left and right images of the XR intelligent glasses when the trigger fingertip does not actually touch the trigger region according to the present invention;

FIG. 10 is a schematic diagram of a relative positioning of the trigger fingertip and two trigger determination points in combined left and right images of the XR intelligent glasses when the trigger fingertip touches the trigger region according to the present invention;

FIG. 11 illustrate four separate images showing relative positioning of the trigger fingertip and the two trigger determination points, where the upper two images show images from the left camera and the right camera respectively when the trigger fingertip does not touch a trigger region, and the lower two images show images from the left camera and the right camera respectively when the trigger fingertip touches a trigger region; and

FIG. 12 is a structural block diagram of a head-mounted display device according to the present invention.

### DETAILED DESCRIPTION OF THE INVENTION

The technical solutions in the embodiments of the present application will be clearly and thoroughly described below with reference to the accompanying drawings of the embodiments of the present application. It is obvious that the described embodiments illustrate only some but not all of the embodiments of the present application. Based on the embodiments of the present application, all other embodiments obtainable by those of ordinary skills in the art without any need of inventive effort shall fall within the protection scope of the present application.

Moreover, the terms “comprise” and “include” and any variations thereof are intended to be an non-exclusive inclusion. For example, a process, method, system, product, or server including a series of steps or units is not necessarily limited to the explicitly listed steps or units, but may include other steps or units that are not explicitly listed or are known to such process, method, product, or device.

In the embodiments of the present application, use of the terms “exemplary” or “for example” is intended to present relevant concepts in a specific manner.

The principles of the technical solutions of the present invention are as follows:

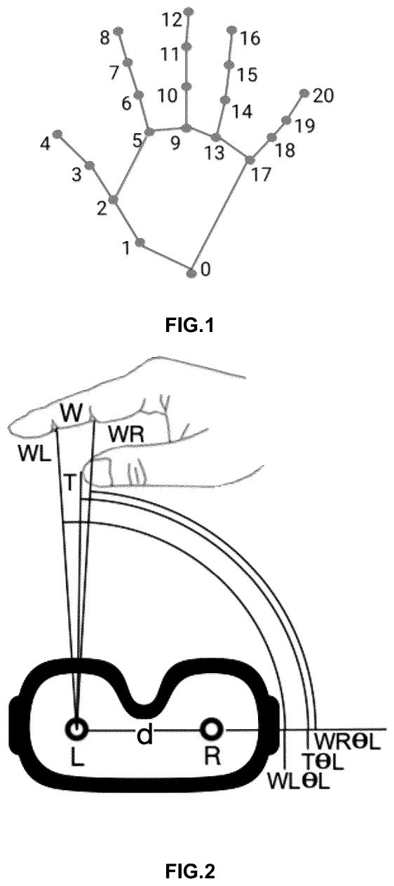

(1) Recognition model used to acquire positional information on a palm: an open source software currently available in the market for a pre-trained human hand joint detection model that can acquire two dimensional positions of human hand joints can be used. The present invention uses Mediapipe as an illustrative example. As an open source project of Google, Mediapipe is a tool library for machine learning which mainly pertains to visual algorithms, and integrates a large sum of models relating to face detection, face key points, gesture recognition, head segmentation, and posture recognition. As shown in FIG. 1, positional information of 21 joint points (also referred to as key points) of a human hand in a video bearing a time sequence can be outputted. Generally, a human hand joint detection model outputs joint positional information in form of (X, Y) pixels being coordinates of an X-axis and a Y-axis of the video. The present invention can also use a self-trained human hand joint detection model. The present invention also comprises learning and recognition by using an artificial intelligence chip such as a graphics processing unit (GPU) or a neural network processing unit (NPU) through label convolution KNN or RNN or through a Transformer model plus Reinforced or any strengthening pre-training methods.

### (2) Calculation of the Spatial Position of a Joint Point:

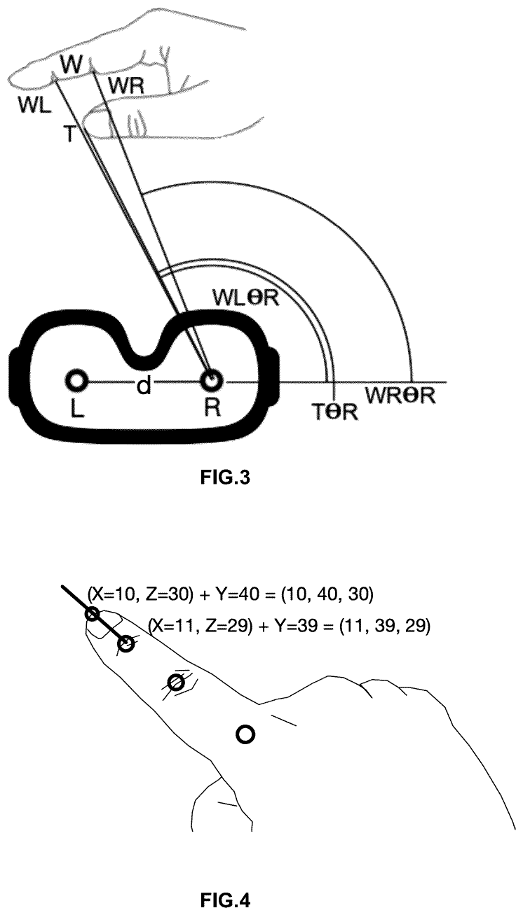

As shown in FIG. 2, treating a connecting line passing through central points L/R of both left and right cameras of a pair of XR intelligent glasses as an X-axis, and in a field of vision of the left camera, an included angle defined as TΘL is formed between the X-axis and a connecting line connecting the central point L of the left camera and a targeted joint point T whose spatial position is yet to be calculated. Similarly, as shown in FIG. 3, in a field of vision of the right camera, an included angle defined as TΘR is formed between the X-axis and a connecting line connecting the central point R of the right camera and a targeted joint point T whose spatial position is yet to be calculated.

A parallax distance between the two central points L and R of the left and right cameras is set as d, and a position (X, Z) of the targeted joint point T is calculated as follows:

If the targeted joint point T is located between the two central points L and R of the left and right cameras:

$$Z = d / [ TAN ( T θ L ) - TAN ( T θ R - π / 2 ) ] , X = Z * TAN ( T θ L ) ; \qquad ( 1 )$$

If the targeted joint point T is located on a left side of the central point L of the left camera:

$$Z = d / [ TAN ( T θ R - π / 2 ) - TAN ( T θ L - π / 2 ) ] , X = - Z * TAN ( T θ L ) ; \qquad ( 2 )$$

If the targeted joint point T is located on a right side of the central point R of the right camera:

$$Z = d / [ COT ( T θ L ) - COT ( T θ R ) ] , X = Z / Tan ( T θ L ) . \qquad ( 3 )$$

The above examples are calculated by using TAN and COT, but any other trigonometric calculation methods can be used by the present invention.

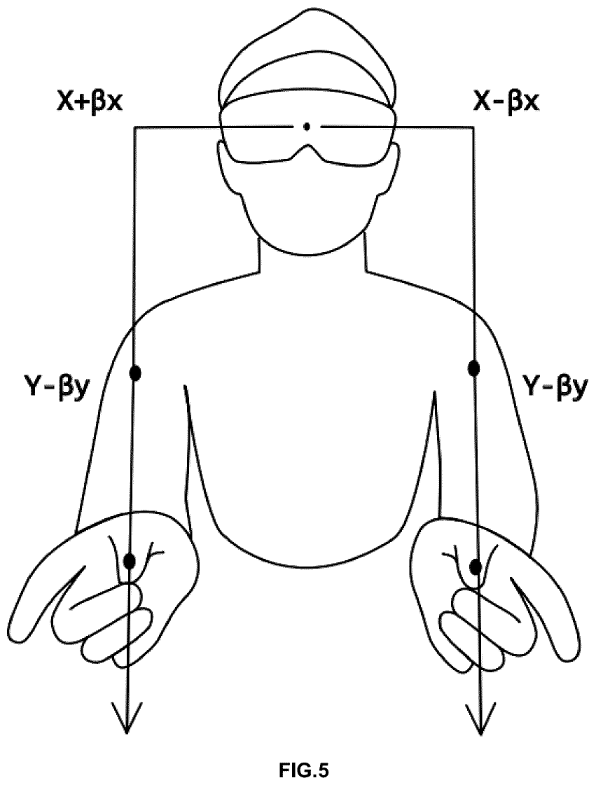

Since the X-axis is defined as a straight connecting line passing through central points L/R of both left and right cameras of the XR intelligent glasses, the parallax exists only on the X-axis. Therefore, no parallax exists on the Y-axis. In other words, the Y-axis value of the images perceived by the left and right eyes must be the same. A reference point for determination of the Y-axis value can be defined as a lowest point or other definable positions of the video images perceived from the left and right cameras. Therefore, a number of Y pixels (or any converted distance unit therefor) counted upwards from the reference point is the Y-axis value. Adding this Y-axis value to the targeted joint point position (X, Z) forms a complete targeted joint point position (X, Y, Z), as shown in FIG. 4.

### (3) Acquiring a Spatial Position of a Preset Light Source:

A light ray is required to form a three-dimensional cursor in a virtual space, and emission of the light ray requires an emission source or a preset light source. A weighted mean position of a certain preset joint/fingertip or a plurality of joints which a light ray projected from the light source passes through before projecting further to a distant position is defined as a control aiming point. An emission direction of the light ray is defined by the light ray emitted from the preset light source passing through the control aiming point; such light ray emitted from the light source is defined as an interactive control line; a “shadow” or a three-dimensional cursor is displayed at a distal end of the interactive control line projected on a surface of a certain virtual object.

If the preset light source is positioned within a visible range of the XR intelligent glasses, and is also a certain preset joint (but not being a control aiming point) on the two hands, then a spatial position of the preset light source can be acquired by using the calculation method for the spatial position of the joint point in the above point (2) as described.

If the preset light source is not positioned within the visible range of the XR intelligent glasses, a position of the light source is usually set on the XR intelligent glasses or at a position relative to the XR intelligent glasses (an Offset position). Generally, if the light source is set on a middle position of the XR intelligent glasses between the left and right cameras, the light ray will be projected from the light source, passing through a control aiming point usually being a fingertip of a thumb on its way, and then eventually projected onto a distant object to display a three dimensional cursor, but unfortunately, the three dimensional cursor is always being visually blocked by the thumb and hence the user is unable to see the three dimensional cursor through the XR intelligent glasses. Alternatively, patents and non-patent literatures in the state of art always mention the use of shoulder or crotch as a position of the light source; however, the patents and non-patent literatures in the state of art have not disclosed how to calculate the three-dimensional spatial position of the shoulder or crotch. In the present invention, a relative position (an Offset position) relative to a central point (X_{center}, Y_{center}) of the XR intelligent glasses between the left and right cameras is used as the light source. If the fingertip of the thumb of the right hand is used as the control aiming point, the position of the light source (X_{light source}, Y_{light source}) being the relative position (the Offset position) relative to the central point of the XR intelligent glasses is defined as X_{light source}=X_{center}+βx, and Y_{light source}=Y_{center}−βy; if the fingertip of the thumb of the left hand is used as the control aiming point, the position of the light source (X_{light source}, Y_{light source}) being the relative position (the Offset position) relative to the central point of the XR intelligent glasses is defined as X_{light source}=X_{center}−βx, and Y_{light source}=Y_{center}−βy, wherein offset values βx and βy can be preset as desired, for example, can be 20 cm and 30 cm. As shown in FIG. 5, in this case, the relative position of the light source is not in the middle of the XR intelligent glasses but is beside and below the XR intelligent glasses; therefore, the three-dimensional cursor projected from the light source onto a certain virtual object passing through the fingertip of the thumb being the control aiming point on its way will not be blocked by the hand of the user and can be clearly visible.

### (4) Determination of Whether a Trigger Fingertip P Touches a Trigger Region:

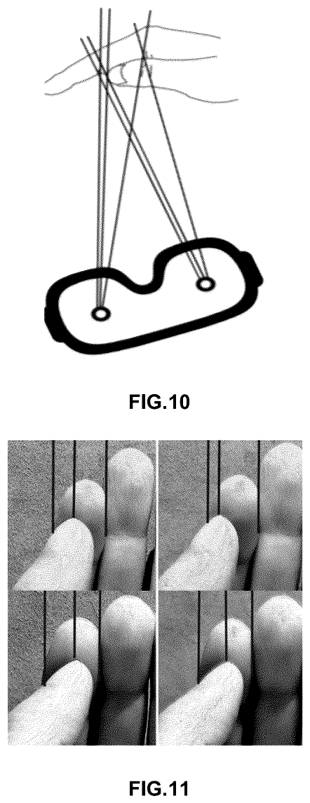

The trigger region is set with a width W; a left trigger determination point WL and a right trigger determination point WR are set at positions W/2 to the left and W/2 to the right of a central point of the trigger region respectively along a direction parallel to an X-axis, in other words, the left trigger determination point WL and the right trigger determination point WR are points corresponding to left and right boundaries of the trigger region respectively. The system acquires N number of video streams with parallax from at least two cameras, wherein N is an integer, and N≥2, track and determine whether the trigger fingertip P is located between the left trigger determination point WL and the right trigger determination point WR corresponding to the trigger region in all corresponding N number of images bearing a same time from said N number of video streams respectively, and if yes, calculate positional information of three target points which are the left trigger determination point WL, the trigger fingertip P, and the right trigger determination point WR for each of said N number of images bearing the same time; then in each of said N number of images bearing the same time, X-axis values (WRX, PX, and WLX) of the positional information of the three target points in that image are used to calculate a ratio (PX−WRX):(WLX−PX) which is a difference in value between PX and WRX to a difference in value between WLX and PX; as shown in FIGS. 9-11, only when all ratios calculated in all of said N number of images bearing the same time are the same, the trigger fingertip is determined to have touched the trigger region which is the fingertip of the thumb. FIG. 4 shows alternative positions of the light source set on joint points within the visible range of the XR intelligent glasses. The function of projecting the shadow or cursor can be achieved as long as the light source and the control aiming point are both within the visible range of the cameras of the XR intelligent glasses.

(5) Method for Achieving Virtual Touch Control with the Three-Dimensional Cursor:

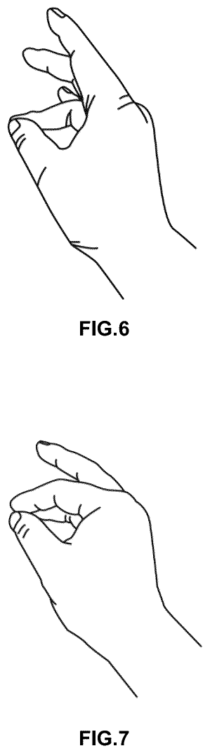

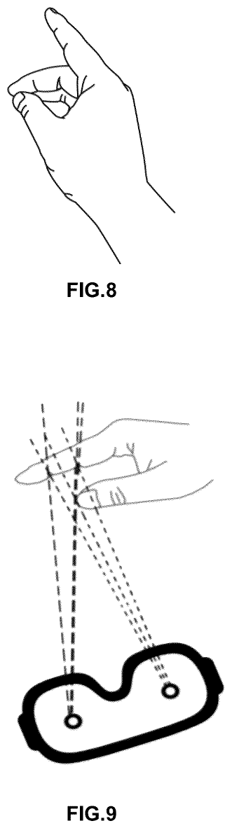

A trigger region, at least one click finger, and at least one switch finger are assigned to the control aiming point. In the embodiment, the fingertip of a thumb is set as the control aiming point, an index finger is set as said at least one click finger, and at least one of the other three fingers which are a middle finger, a ring finger, and a little finger, is set as the switch finger for activating the three-dimensional cursor projection. When the switch finger touches the trigger region, the spatial positions of the control aiming point and the preset light source are acquired, and then a light ray projected from the preset light source are projected to the control aiming point as a straightly projected light ray or a non-straight projected light ray, and the straightly projected light ray or the non-straight projected light ray projects further outwards from the control aiming point resembling a projected laser from a laser pen (straight line) or a launched fishing rod (parabola), and such projected light ray from preset light source is said interactive control line; before the click finger has ever clicked the trigger region, the interactive control line will disappear once the switch finger leaves and does not touch the trigger region. When there is the interactive control line, changing a direction which the control aiming point points to can guide the interactive control line to move; when the interactive control line and a virtual object (or a virtual model of a real object) in a virtual space intersect, a three-dimensional cursor is displayed at that intersecting point, and if at this moment, the click finger also touches the trigger region, various mouse operations such as clicking, dragging, selecting, and drawing are performed on the virtual object touched by the three-dimensional cursor. If it is desired to achieve the left and right mouse button operations, two different click fingers can be defined; for example, as shown in FIGS. 6 to 8, the fingertip of the thumb is set as the control aiming point, the index finger is set as the right button click finger, the middle finger is set as the left button click finger, and the ring finger is set as the switch finger for activating the three-dimensional cursor. After the ring finger touches the fingertip of the thumb to display the interactive control line, if the index finger also touches the trigger region, the right mouse button click action is performed, and if instead the middle finger also touches the trigger region, the left mouse button click action is performed.

(6) Achieving Virtual Control Such as Virtual Drawing and Writing with a Three-Dimensional Paintbrush:

The interactive control line is a virtual paintbrush with a preset length, and the distal end of the interactive control line is a pen tip position. By touching the trigger region by the click finger, the pen tip of the virtual paintbrush can draw points or strokes in a virtual space, such that writing or drawing in a virtual space is achieved to simulate real drawing and writing.

### Embodiment 1

Embodiment 1 of the present invention relates to a method for achieving virtual touch control with a three-dimensional cursor, applicable to a system using an extended reality (XR) wearable device or an extended reality headset; wherein in a virtual space, a weighted mean position of a certain preset joint/fingertip or a plurality of joints of a human hand which a light ray projected from a preset light source passes through before projecting further to a distant position is defined as a control aiming point; the light ray projected from the preset light source, passing through the control aiming point, and being projected onto the distant position is defined as an interactive control line, and the three-dimensional cursor is displayed at a distal end of the interactive control line; the method comprises the following steps:

Step 1: assigning a trigger region for the control aiming point, and assigning at least one switch finger for activating projection of the three-dimensional cursor and at least one click finger for touching the trigger region; in this embodiment, a fingertip of a thumb is set as the control aiming point; an index finger is set as said at least one click finger; and one of a middle finger, a ring finger, and a little finger is set as said at least one switch finger for activating projection of the three-dimensional cursor, or the middle finger, the ring finger, and the little finger are respectively set as different switch fingers, wherein said different switch fingers are defined to activate different functions;

Step 2: when any one of said at least one switch finger touches the trigger region, spatial positions of the control aiming point and the preset light source are acquired, and then the light ray projected from the preset light source, passing through the control aiming point, and being projected onto the distant position forms said interactive control line; before said at least one click finger has ever clicked the trigger region, the interactive control line will disappear once said at least one switch finger leaves and does not touch the trigger region; when there is the interactive control line, changing a direction which the control aiming point points to guides the interactive control line to move; when the interactive control line and a virtual object or a virtual model of a real object in a virtual space intersect, the three-dimensional cursor is displayed at that intersecting point, and if at this moment, the click finger also touches the trigger region, virtual touch control is performed on the virtual object or the virtual model touched by the three-dimensional cursor.

Specific calculation for acquiring the spatial positions of the control aiming point and the preset light source comprises the following steps:

If the preset light source is positioned within a visible range of a pair of XR intelligent glasses, and is also a certain preset joint, yet not being said control aiming point, on two hands, then the spatial positions of the control aiming point and the preset light source are acquired by using a same calculation method as follows: treating a connecting line passing through central points L/R of both left and right cameras of the XR intelligent glasses as an X-axis, and in a field of vision of the left camera, an included angle defined as TΘL is formed between the X-axis and a connecting line connecting the central point L of the left camera and a targeted joint point T whose spatial position is yet to be calculated; similarly, as shown in FIG. 3, in a field of vision of the right camera, an included angle defined as TΘR is formed between the X-axis and a connecting line connecting the central point R of the right camera and a targeted joint point T whose spatial position is yet to be calculated;
a parallax distance between the two central points L and R of the left and right cameras is set as d, and a position (X, Z) of the targeted joint point T is calculated as follows:
if the targeted joint point T is located between the two central points L and R of the left and right cameras:

$$Z = d / [ TAN ( T θ L ) - TAN ( T θ R - π / 2 ) ] , X = Z * TAN ( T θ L ) ; \qquad ( 1 )$$

if the targeted joint point T is located on a left side of the central point L of the left camera:

$$Z = d / [ TAN ( T θ R - π / 2 ) - TAN ( T θ L - π / 2 ) ] , X = - Z * TAN ( T θ L ) ; \qquad ( 2 )$$

if the targeted joint point T is located on a right side of the central point R of the right camera:

$$Z = d / [ COT ( T θ L ) - COT ( T θ R ) ] , X = Z / Tan ( T θ L ) ; \qquad ( 3 )$$

a reference point for determination of a Y-axis value is any point on a lowest side of video images perceived from the left and right cameras; a Y pixel value of the targeted joint point T counted upwards from the reference point is the Y-axis value of a spatial position (X, Y, Z) of the targeted joint point T;

If the preset light source is not positioned within the visible range of the XR intelligent glasses, the spatial position of the preset light source is calculated by a method different from that of the method for calculating the spatial position of the control aiming point as described above: a relative position relative to a central point (X_{center}, Y_{center}) of the XR intelligent glasses between the left and right cameras is used as the preset light source; if a joint/the fingertip of the thumb of a right hand is used as the control aiming point, the position of the preset light source (X_{light source}, Y_{light source}) being the relative position relative to the central point of the XR intelligent glasses is defined as X_{light source}=X_{center}+βx, and Y_{light source}=Y_{center}−βy; if the a joint/the fingertip of the thumb of a left hand is used as the control aiming point, the position of the light source (X_{light source}, Y_{light source}) being the relative position relative to the central point of the XR intelligent glasses is defined as X_{light source}=X_{center}−βx, and Y_{light source}=Y_{center}−βy, wherein βx and βy are offset values;

Steps for determining whether a trigger finger P being said at least one switch finger or said at least one click finger touches the trigger region:

the trigger region assigned to the control aiming point is set with a width W; a left trigger determination point WL and a right trigger determination point WR are set at positions W/2 to the left and W/2 to the right of a central point of the trigger region respectively along a direction parallel to an X-axis, in other words, the left trigger determination point WL and the right trigger determination point WR are points corresponding to left and right boundaries of the trigger region respectively; the system acquires N number of video streams with parallax from at least two cameras of the XR intelligent glasses, wherein N is an integer, and N≥2, track and determine whether the trigger fingertip P is located between the left trigger determination point WL and the right trigger determination point WR corresponding to the trigger region in all corresponding N number of images bearing a same time from said N number of video streams respectively, and if yes, calculate positional information of three target points which are the left trigger determination point WL, the trigger fingertip P, and the right trigger determination point WR for each of said N number of images bearing the same time; then in each of said N number of images bearing the same time, X-axis values (WRX, PX, and WLX) of the positional information of the three target points in that image are used to calculate a ratio (PX−WRX):(WLX−PX) which is a difference in value between PX and WRX to a difference in value between WLX and PX; only when all ratios calculated in all of said N number of images bearing the same time are the same, the trigger fingertip P is determined to have touched the trigger region

The virtual touch control refers to that the fingertip of the thumb is set as the control aiming point; one of remaining four fingers, for example an index finger, is selected as the click finger; and at least one of yet remaining three fingers is set as the switch finger for activating projection of the three-dimensional cursor; if a plurality of switch fingers are set, the plurality of switch fingers are defined to activate different functions. For example, the middle finger corresponds to activation of a three-dimensional cursor, and the ring finger corresponds to activation of a virtual paintbrush.

The virtual touch control refers to that the fingertip of the thumb is set as the control aiming point; one of remaining four fingers, for example a ring finger, is selected as the switch finger for activating projection of the three-dimensional cursor; and two of yet remaining three fingers, for example an index finger and a middle finger, are respectively defined as a right mouse button click finger and a left mouse button click finger.

The interactive control line is a projected light ray of indefinite length, which is a straight light ray resembling a laser projected from a laser pen or a parabolic light ray resembling a launched fishing rod.

The interactive control line is a virtual paintbrush with a preset length, and a distal end of the interactive control line is a pen tip position. While displaying the virtual paintbrush, by also touching the trigger region with the click finger, the pen tip draws points or strokes in a virtual space, thereby achieving a function of drawing or writing.

Those skilled in the art should further appreciate that portions and algorithm steps of various examples described with reference to the embodiments disclosed herein can be implemented through electronic hardware, computer software, or a combination thereof. In order to clearly illustrate the interchangeability of implementation through hardware and software, the components and steps of various examples have been generally described in terms of their operative features in the above description. Whether these features are performed through hardware or software depends on the constraints and conditions of the technical solutions proposed in the context of a particular utilization or design. Those skilled in the art may implement the described features in various ways for each particular example of utilization, and such various ways of implementation are not to be considered exceeding the scope of the present invention.

Specifically, the steps of the method disclosed in the embodiments of the present application may be performed through a processor by hardware integrated logic circuits and/or software commands. The steps of the method disclosed with reference to the embodiments of the present application may be directly embodied as being performed by a hardware coding processor, or performed by a combination of hardware and software modules in the coding processor. Optionally, the software modules may be located in well-known storage medium in the art, such as a random access memory, a flash memory, a read-only memory, a programmable read-only memory, an electrically erasable programmable memory, or a register. The storage medium is located in a storage device; the processor reads information in the storage device and implements the method steps of the above embodiments in combination with the hardware of the processor.

### Embodiment 2

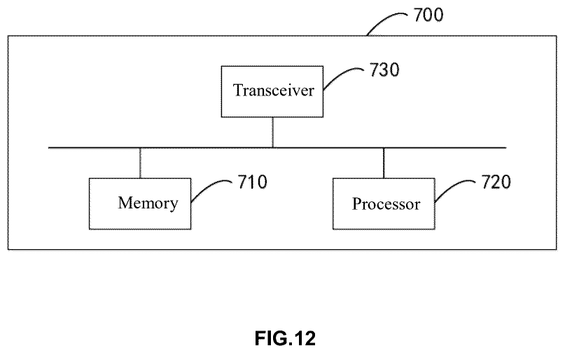

Embodiment 2 of the present invention provides a head-mounted display device. As shown in FIG. 12, the head-mounted display device 700 comprises: a memory 710 and a processor 720; wherein the memory 710 is configured to store a computer program and transmit program codes to the processor 720. In other words, the processor 720 can call and run the computer program from the memory 710 to perform the methods in the embodiments of the present application. For example, the processor 720 can be configured to perform the processing steps in the method described according to an embodiment of the present invention based on commands configured in the computer program.

In some embodiments of the present application, the computer program can be divided into one or more modules, and said one or more modules are stored in the memory 710 and executed by the processor 720 to perform the method of an embodiment provided by the present application. Said one or more modules may be a series of computer program command segments capable of performing specific functions, and the command segments are defined to describe the execution of the computer program on the head-mounted display device 700.

As shown in FIG. 12, the head-mounted display device further comprises a transceiver 730, which is connected to the processor 720 or the memory 710. The processor 720 can control the transceiver 730 to communicate with other devices, specifically, to send information or data to other devices, or to receive information or data sent from other devices. The transceiver 730 may at least comprise two cameras configured to take videos/images of a targeted region.

It should be appreciated that the various components in the head-mounted display device 700 are connected through a bus system, where the bus system includes a power bus, a control bus, and a status signal bus in addition to a data bus.

### Embodiment 3

Embodiment 3 of the present invention further provides a computer storage medium in which a computer program is stored, wherein the computer program, when run by a computer, enables the computer to perform the processing steps described in the method according to the above Embodiment 1.

### Embodiment 4

Embodiment 4 of the present invention further provides a chip for executing commands, wherein the chip comprises an integrated circuit substrate encapsulated inside, and the integrated circuit substrate is configured to perform the processing steps described in the method according to the above Embodiment 1.

The above specific embodiments further illustrate the objectives, technical solutions, and beneficial effects of the present invention, and it should be appreciated that the foregoing shows only specific embodiments of the present invention and is not intended to limit the protection scope of the present invention. Any modification, equivalent substitution, improvement, and the like made without departing from the spirit and principle of the present invention shall fall within the protection scope of the present invention.

What is claimed is:

1. A method for achieving virtual touch control with a three-dimensional cursor, applicable to a system using an extended reality wearable device or an extended reality headset; wherein in a virtual space, a weighted mean position of a certain joint or fingertip or a plurality of joints of a human hand which a light ray projected from a preset light source passes through before projecting further to a distant position is defined as a control aiming point; the light ray projected from the preset light source, passing through the control aiming point, and being projected onto the distant position is defined as an interactive control line, and the three-dimensional cursor is displayed at a distal end of the interactive control line; the method comprises the following steps:
Step 1: assigning a trigger region for the control aiming point, and assigning at least one switch finger for activating projection of the three-dimensional cursor and at least one click finger for touching the trigger region;
Step 2: when any one of said at least one switch finger touches the trigger region, spatial positions of the control aiming point and the preset light source are acquired, and then the light ray projected from the preset light source, passing through the control aiming point, and being projected onto the distant position forms said interactive control line; before said at least one click finger has ever clicked the trigger region, the interactive control line disappears once said at least one switch finger leaves and does not touch the trigger region; when there is the interactive control line, changing a direction which the control aiming point points is capable of guiding the interactive control line to move; when the interactive control line and a virtual object or a virtual model of a real object in a virtual space intersect, the three-dimensional cursor is displayed at that intersecting point, and if at this moment, the click finger also touches the trigger region, virtual touch control is performed on the virtual object or the virtual model touched by the three-dimensional cursor.

2. The method of claim 1, wherein, the spatial positions of the control aiming point and the preset light source are acquired through the following steps:
if the preset light source is positioned within a visible range of a pair of XR intelligent glasses, and is also a certain preset joint, yet not being said control aiming point, on any one of two hands, then the spatial positions of the control aiming point and the preset light source are acquired by using a same calculation method as follows: treating a connecting line passing through central points L/R of both left and right cameras of the XR intelligent glasses as an X-axis, and in a field of vision of the left camera, an included angle defined as TΘL is formed between the X-axis and a connecting line connecting the central point L of the left camera and a targeted joint point T whose spatial position is yet to be calculated; similarly, in a field of vision of the right camera, an included angle defined as TΘR is formed between the X-axis and a connecting line connecting the central point R of the right camera and the targeted joint point whose spatial position is yet to be calculated; a parallax distance between the two central points L and R of the left and right cameras is set as d, and a position (X, Z) of the targeted joint point T is calculated as follows:
if the targeted joint point T is located between the two central points L and R of the left and right cameras:
$$Z = d / [ TAN ( T θ L ) - TAN ( T θ R - π / 2 ) ] , X = Z * TAN ( T θ L ) ; \qquad ( 1 )$$
if the targeted joint point T is located on a left side of the central point L of the left camera:
$$Z = d / [ TAN ( T θ R - π / 2 ) - TAN ( T θ L - π / 2 ) ] , X = - Z * TAN ( T θ L ) ; \qquad ( 2 )$$
if the targeted join point T is located on a right side of the central point R of the right camera:
$$Z = d / [ COT ( T θ L ) - COT ( T θ R ) ] , X = Z / Tan ( T θ L ) ; \qquad ( 3 )$$
a reference point for determination of a Y-axis value is any point on a lowest side of video images perceived from the left and right cameras; a Y pixel value of the targeted joint point T counted upwards from the reference point is the Y-axis value of a spatial position (X, Y, Z) of the targeted joint point;
if the preset light source is not positioned within the visible range of the XR intelligent glasses, the spatial position of the preset light source is calculated by a method different from that of the method for calculating the spatial position of the control aiming point as described above; the spatial position of the preset light source is calculated as follows: a relative position relative to a central point (X_{center}, Y_{center}) of the XR intelligent glasses between the left and right cameras is used as the preset light source; if a joint or a fingertip of a thumb of a right hand is used as the control aiming point, a position of the preset light source (X_{light source}, Y_{light source}) being the relative position relative to the central point of the XR intelligent glasses is defined as X_{light source}=X_{center}+βx, and Y_{light source}=Y_{center}−βy; if the a joint or a fingertip of a thumb of a left hand is used as the control aiming point, a position of the light source (X_{light source}, Y_{light source}) being the relative position relative to the central point of the XR intelligent glasses is defined as X_{light source}=X_{center}−βx, and Y_{light source}=Y_{center}−βy, wherein βx and βy are offset values.

3. The method of claim 1, wherein steps for determining whether a trigger finger P being said at least one switch finger or said at least one click finger touches the trigger region:
the trigger region assigned to the control aiming point is set with a width W; a left trigger determination point WL and a right trigger determination point WR are set at positions W/2 to the left and W/2 to the right of a central point of the trigger region respectively along a direction parallel to an X-axis, in other words, the left trigger determination point WL and the right trigger determination point WR are points corresponding to left and right boundaries of the trigger region respectively; the system acquires N number of video streams with parallax from at least two cameras of the XR intelligent glasses, wherein N is an integer, and N≥2, track and determine whether the trigger fingertip P is located between the left trigger determination point WL and the right trigger determination point WR corresponding to the trigger region in all corresponding N number of images bearing a same time from said N number of video streams respectively, and if yes, calculate positional information of three target points which are the left trigger determination point WL, the trigger fingertip P, and the right trigger determination point WR for each of said N number of images bearing the same time; then in each of said N number of images bearing the same time, X-axis values (WRX, PX, and WLX) of the positional information of the three target points in that image are used to calculate a ratio (PX−WRX):(WLX−PX) which is a difference in value between PX and WRX to a difference in value between WLX and PX; only when all ratios calculated in all of said N number of images bearing the same time are the same, the trigger fingertip P is determined to have touched the trigger region.

4. The method of claim 1, wherein the virtual touch control refers to that the fingertip of a thumb is set as the control aiming point; one of remaining four fingers is selected as the click finger; and at least one of yet remaining three fingers is set as the switch finger for activating projection of the three-dimensional cursor; if a plurality of switch fingers are set, the plurality of switch fingers are defined to activate different functions.

5. The method of claim 1, wherein the virtual touch control refers to that the fingertip of a thumb is set as the control aiming point; one of remaining four fingers is selected as the switch finger for activating projection of the three-dimensional cursor; and two of yet remaining three fingers are respectively defined as a right mouse button click finger and a left mouse button click finger.

6. The method of claim 1, wherein the interactive control line is a projected light ray of an indefinite length, which is a straight light ray or a parabolic light ray.

7. The method of claim 1, wherein the interactive control line is a virtual paintbrush with a preset length; while displaying the virtual paintbrush, by touching the trigger region with the click finger, a pen tip of the virtual paintbrush draws points or strokes in the virtual space, thereby achieving a function of drawing or writing.

8. A head-mounted display device, at least comprising two cameras configured to take videos and/or images of a targeted region; the head-mounted display device comprises a memory and a processor; wherein the memory is configured to store a computer program; the processor is configured to execute the computer program to perform the method according claim 1.
